(19) United States
(12) Patent Application Publication
(10) Pub. No.: US 2013/0278398 A1
(43) Pub. Date: Oct. 24, 2013

(54) APPARATUS AND METHOD FOR REMOTELY SETTING MOTION VECTOR FOR SELF-PROPELLED TOY VEHICLES

(71) Applicants: Evgeny Nikolayevich Smetanin, Moscow (RU); Alexey Vladimirovich Chechendaev, Moscow (RU)

(72) Inventors: Evgeny Nikolayevich Smetanin, Moscow (RU); Alexey Vladimirovich Chechendaev, Moscow (RU)

(21) Appl. No.: 13/823,111

(22) PCT Filed: Sep. 14, 2011
(86) PCT No.: PCT/RU11/00704

§ 371 Date: Mar. 14, 2013

Related U.S. Application Data
(60) Provisional application No. 61/382,631, filed on Sep. 14, 2010.

(51) Int. Cl. G08C 19/16

(52) U.S. Cl. CPC G08C 19/16
USPC 340/12.52; 340/12.22

(57) ABSTRACT

The present solution is directed to systems and methods for setting motion vector (MV) for a self-propelled toy by hand-held remote controller (RC). The method feature is that (i) the vector of a control action made by the user with the RC, (ii) the vector of the desired motion for the selected toy and (iii) the vector displayed by light indicator at the selected toy, all the three, or at least two of them, have coincided direction and proportional value. The desired vector is being set while the RC is pointed at the selected toy. If pointing is being made by invisible light, then the pointed toy should be indicated by its own means. One RC may be used for controlling arbitrary number of devices consequently. Otherwise a number of toys may be grouped, and the same MV may be given to all of them at once.

### RELATED APPLICATION

This application claims the benefit of and priority to U.S. Provisional Patent Application No. 61/382,631 entitled “Apparatus and Method For Remotely Setting Motion Vector For Self-Propelled Toy Vehicles” and filed on Sep. 14, 2010, which is incorporated herein by reference in its entirety.

### BACKGROUND

### First-Third Face Confusion.

Most of the remote controllers (RC) for guiding toy vehicles have a fundamental inconvenience. A user guides a controlled vehicle in the first person, as if he/she sits inside the vehicle's cockpit. However, the user views the guided vehicle in the third face, i.e. from the outside. That's why, when the vehicle is oriented ‘face-to-face’ to the user, it makes a confusion: to guide the vehicle towards oneself one should move the RC lever outwards oneself; to turn the vehicle to the right one should move the RC lever to the left. In such situations users often make mistakes.

Remote controlling might be much easier and intuitive if the defined motion vector of the vehicle coincided with the defining motion vector of the RC lever or joystick.

### RF Channel Inconvenience

Conventional RF remote controllers require radio frequency channels management. Usually both a remote controller and a controlled device have switches or jumpers for choosing one of the supported channels. The user has to choose one channel and make appropriate settings on both the remote controller and the controlled device. If this channel is suppressed by noise or by other system the user has to try another channel and make setting on both devices again. If a game system contains several controlled devices, then the user has to change settings in all the controlled devices. This is annoying.

No Method Exists for Simultaneously Controlling Variously Designed Toys with the Same RC.

Present optical RCs are tied to a concrete locomotion engine design. That's not universal. No method exists for assembling a toy team including variously designed toys controllable by the same RC. No effective method exists for controlling a number of toys in a toy team by simple pointing (selecting) a toy with an RC and giving it a command by one touch.

### SUMMARY OF THE INVENTION

The idea of optical remote control is very tempting. Lots of good inventions were made for RC vehicles through the years. Many of the issued patents are 20 years and older. However, new applications in the field appear every year. This is because the increasing diversity of self-propelled toys and toy robots is steel seeking for the most effective and universal remote control method. In last two decades computer games created a pattern of managing game units (especially in strategy games and sport simulators?) by highlighting the selected character, directing it in one click and easy hopping between the units or groups of the selected units. Recent expectations of “Toy stories” playable with real toys again issue a challenge of creating a simple and intuitive remote control method. This cannot be done without a kind of light pointer. Moreover, such a pointer should be suitable for one-touch setting of motion parameters, managing number of units with one control etc. And it should eliminate some well known problems like changeable impact of ambient light and others. The present solution addresses, solves or eliminates the problems and challenges. The approach on which the present invention is based is cheap, safe for children and widely available components may be used for production. Unlimited compatibility with all kinds of the existing self-propelled toys is provided. Most of the particular solutions used in embodiments of the present solution are use-proven.

One aspect of the present invention is a method for setting motion vector (MV) for a self-propelled toy by hand-held remote controller (RC). The method feature is that (i) the vector of a control action made by the user with the RC, (ii) the vector of the desired motion for the selected toy and (iii) the vector displayed by light indicator at the selected toy, all the three, or at least two of them, have coincided direction and proportional value. The desired motion vector is being set while the RC is pointed at the selected toy. If pointing is being made by invisible light or otherwise invisible means, then the pointed toy should be highlighted or otherwise indicated by its own means. The method is suitable for controlling self-propelled toy vehicles and toy robots of any kind. One RC may be used for controlling arbitrary number of self-propelled devices by consequent setting motion vector for each of them. Otherwise a number of toys may be grouped, and the same motion vector may be given to all of them at once.

Another aspect of this invention is a control system comprised of a handheld RC and MV module attached to or built in the self-propelled toy.
The user (i) points the toy to be selected with a light beam emitted by the RC, (ii) sets the desired motion vector by shifting the RC joystick or by another method provided by the RC means, (iii) corrects motion vector with a glance at the indicator on the selected toy (if needed), (iv) lets the first toy go autonomously and selects a new one by moving the light beam away from the first toy and pointing the new one.
The RC (i) highlights the selected toy with the emitted light, (ii) detects the desired motion vector by the method provided by its means, (iii) converts the detected values to polar coordinates relative to the emitted light beam axis, (iv) transmits the motion vector values to the selected toy (if any) to define its motion parameters. For example, joystick displacement made by just one finger move can detect (a) direction, (b) speed and (c) duration of the desired motion.
The MV-module (i) detects if the toy is selected, (ii) detects direction of light emitted by RC and passed though (or near) the MV-module center while the RC is pointing at the toy, (iii) receives the desired motion vector values in polar coordinates relative to direction of emitted light, (iv) converts the received values to its own polar coordinates, (v) indicates the converted motion vector by its own means (if any) or translates it to be otherwise indicated by the toy, (vi) gets the correction from the user (if any), (viii) either converts the final desired motion vector into executed commands in accordance with the toy's locomotion engine or transmits the same to the toy's engine controller for further processing.
   If the desired motion cannot be exactly performed because of the engine's limitations, then the motion vector values are reduced to the closest possible values convertible to the executed commands. In some embodiments, modulated light is used for data transmitting by the RC, and radially symmetrical sited photo-sensors are used in the MV-module at the toy for defining the control axis by detecting the RC light beam. Yet a number of other means for the same control method exists as further described herein.

Yet another aspect of the present invention is a game system comprised of an arbitrary number of self-propelled toys considered as game units and several remote controllers depending on the number of players. The players may play simultaneously each one controlling one's team of toys. Each team is being formed and tied to the available RC prior to the game. Unification of the units' engines is not required—some of them may be caterpillar tanks, some classical four-wheeled cars, some robot insects, some androids—members of one team are controlled by the same RC with the same method (provided that all of them have unified MV-modules). During the game units of one team do not respond to another team's RC signals. After the game is finished all the units are reset, and new teams may be formed at will. Optionally, during the same game some or all of the units may be respondent to more than one remote controller. Grouping of several selected toys may be performed in the same manner as is being done in computer strategic games. The grouped toys may be operated simultaneously with one RC by sending commands to the group as a whole. Every unit in the group a command sent to the group.

In some aspects, the present invention is directed to a method for setting a direction of movement of a self-propelled toy to correspond to the same direction of displacement of a remote controller. The method may include detecting, by a sensor of a remote controller, a displacement of at least a portion of the remote controller and determining, by the remote controller responsive to the sensor, a motion vector corresponding to the displacement. The motion vector may include a direction of the displacement of the remote controller. The method may include transmitting, by the remote controller, the motion vector to a self-propelled toy to request the self-propelled toy to move in the same direction as the displacement of the remote controller and translating, by a motion vector module of the self-propelled toy, the motion vector to a coordinate system of the motion vector module. The method may also include communicating, by the motion vector module based on and an orientation of the self-propelled toy to the coordinate system of the motion vector, commands to the self-propelled toy to execute motion in the same direction as the displacement of the remote controller based on the translated motion vector.

In some embodiments, the method includes specifying a duration of the motion vector based on a time for which the displacement of the remote controller is kept. The method may include communicating to the self-propelled toy to execute motion in the same direction as the displacement of the remote controller for the same duration as the displacement of the remote controller specified via the motion vector.

In some aspects, the present invention is directed to a system for setting a direction of movement of a self-propelled toy to correspond to the same direction of displacement of a remote controller. The system includes a remote controller comprising a sensor detecting a displacement of at least a portion of the remote controller. The system may also include a microcontroller of the remote controller determining, responsive to the sensor, a motion vector corresponding to the displacement, the motion vector comprising a direction of the displacement of the portion of the remote controller. A transmitter of the remote controller may transmit the motion vector to a self-propelled toy to request the self-propelled toy to move in the same direction as the displacement of the portion of the remote controller. A motion vector module of the self-propelled toy may translate the motion vector to a coordinate system of the motion vector module; and based on an orientation of the self-propelled toy to the coordinate system of the motion vector, communicates commands to the self-propelled toy to execute motion in the same direction as the displacement of the remote controller based on the translated motion vector.

In some embodiments, the remote controller specifies a duration for the motion vector based on a time for which the displacement of the remote controller is kept. In some embodiments, the motion vector modules communicates command to the self-propelled toy to execute motion in the same direction as the displacement of the remote controller for the same duration as the displacement of the remote controller specified via the motion vector.

In another aspect, the present invention is directed to a method for remotely setting a motion vector for a self-propelled toy. The method includes selecting, by a remote controller via transmission of a signal towards a self-propelled toy, the self-propelled toy to which to send a command for a motion to be performed. The method includes detecting, by a sensor of the remote controller, a displacement of at least a portion of the remote controller; and determining, by the remote controller responsive to the sensor, a motion vector corresponding to the displacement. The motion vector comprising a direction and a magnitude of the displacement of the portion of the remote controller. The method also includes transmitting, by the remote controller, the motion vector to the selected self-propelled toy to request the self-propelled toy to perform the motion specified by the motion vector.

In some embodiments, the method includes pointing a beam of light from the remote controller at the self-propelled toy, the self-propelled toy providing a visual indicator of being selected. In some embodiments, the method includes providing a visual indicator of selection based on a light spot on the self-propelled toy and a surface supporting the self-propelled toy. In some embodiments, the method includes providing a visual indicator of selection based on light from the remote controller reflecting off a reflective portion of the self-propelled toy. In some embodiments, the method includes providing a visual indicator of selection based on the self-propelled toy switching on a light source of the self-propelled toy.

In some embodiments, the method includes detecting, by the sensor, a gesture of a hand displacing the remote controller. In some embodiments, the method includes detecting, by the sensor, the portion of the remote controller comprising a handle of a joystick. In some embodiments, the method includes detecting, by the sensor, the displacement of a body of the remote controller. In some embodiments, the method includes detecting, by the sensor placed at a distant end of the remote controller, a vertical acceleration and a horizontal acceleration in Cartesian coordinates of at least the portion of the displacement of the remote controller. In some embodiments, the method includes translating, by the remote controller, Cartesian coordinates of a vertical acceleration and a horizontal acceleration determined by the sensor into polar coordinates of the direction and the magnitude of the displacement. In some embodiments, the method includes specifying a duration of the motion vector based on a time for which at least the portion of the displacement of the remote controller is kept. In some embodiments, the method includes transmitting, by the remote controller, the motion vector to the self-propelled toy via one of the following transmission mediums: light, radio frequency (RF) infra-red (IR), ultrasonic and ultra wideband (UWB). In some embodiments, the sensor comprises one of the following: an accelerometer, a joystick or a camera and a touch screen interface. In some embodiments, the method includes transmitting, by the remote controller, the motion vector to the self-propelled toy to request the self-propelled toy to perform the motion in the same direction as the displacement of at least the portion of the remote controller.

In another aspect, the present invention is directed to a system for remotely setting a motion vector for a self-propelled toy. The system may include a remote controller comprising a transmitter for transmitting signals to a self-propelled toy. The remote controller may select the self-propelled toy by transmitting a signal directed towards the self-propelled toy. The system may include a sensor detecting a displacement of at least a portion of the remote controller and a micro-controller responsive to the sensor determining, a motion vector from the displacement. The motion vector may specify a direction and a magnitude of the displacement of the remote controller. The micro-controller may transmit via the transmitter to the self-propelled toy the motion vector to request the self-propelled toy to perform the motion specified by the motion vector.

In some embodiments, the remote controller transmits a beam of light at the self-propelled toy, the self-propelled toy providing a visual indicator of being selected. In some embodiments, a visual indicator of selection comprises a light spot on the self-propelled toy and a surface supporting the self-propelled toy. In some embodiments, a visual indicator of selection a light from the remote controller reflecting off a reflective portion of the self-propelled toy. In some embodiments, a visual indicator of selection comprises the self-propelled toy switching on a light source of the self-propelled toy.

In some embodiments, the sensor detects a gesture of a hand displacing the remote controller. In some embodiments, the sensor detects the portion of the remote controller comprising a handle of a joystick. In some embodiments, the sensor detects the displacement of a body of the remote controller.

In some embodiments, the sensor, placed at a distant end of the remote controller, detects a vertical acceleration and a horizontal acceleration in Cartesian coordinates of the displacement of at least the portion of the remote controller. In some embodiments, the micro-controller translates Cartesian coordinates of a vertical acceleration and a horizontal acceleration determined by the sensor into polar coordinates of the direction and the magnitude of the displacement. In some embodiments, the micro-controller specifies a duration of the motion vector based on a time for which the sensor determines at least the portion of the displacement of the remote controller is kept.

In some embodiments, the transmitter transmits the motion vector via one of the following transmission mediums: light, radio frequency (RF) infra-red (IR), ultrasonic and ultra wideband (UWB). In some embodiments, the sensor comprises one of the following: an accelerometer, a joystick or a camera and a touch screen interface. In some embodiments, the remote controller transmit the motion vector to the self-propelled toy to request the self-propelled toy to perform the motion in the same direction as the displacement of at least the portion of the remote controller.

In yet another aspect, the present invention is directed to a method for receiving by a motion vector module of a self-propelled toy a motion vector transmitted remotely via a remote controller. The method may include establishing, by a motion vector module of a self-propelled toy responsive to a direction of one or more signals from a remote controller, a control axis and receiving, by the motion vector module, a motion vector via the one or more signals, a motion vector comprising a magnitude and a direction. The method may further include translating, by the motion vector module, the motion vector to a coordinate system of the motion vector module based on the control axis, and communicating, by the motion vector module based on an orientation of the self-propelled toy to the coordinate system, commands to the self-propelled toy to execute motion corresponding to the motion vector.

In some embodiments, the method includes communicating, by the self-propelled toy responsive to an optical sensor of the motion vector module sensing the one or more signals, a visual indicator that the self-propelled toy is selected. In some embodiments, the method includes establishing, by the motion vector module, the control axis as one of parallel with or coinciding with a plane of projection of the one or more signals from the remote controller. In some embodiments, the method includes establishing, by the motion vector module, the control axis within a predetermined angle from a plane of projection of the one or more signal. In some embodiments, the method includes comprises communicating, by the self-propelled toy responsive to the motion vector module, a visual indicator that the motion vector has been received. In some embodiments, the method includes communicating, by the self-propelled toy responsive to the motion vector module, a visual indicator that of a direction of a motion vector received by the motion vector module. In some embodiments, the method includes receiving, by the motion vector module, the motion vector further comprising a duration for a motion specified by the motion vector.

In some embodiments, the method includes receiving, by a multi-fold rotationally symmetrical optical sensor of the motion vector module, signals from the remote controller. In some embodiments, the method includes receiving, by a camera of the motion vector module, signals from the remote controller. In some embodiments, the method includes receiving, by a photo detector sensor of the motion vector module, signals from the remote controller. In some embodiments, the method includes receiving, by the motion vector module, a signal comprising a correction from a user to the motion vector.

In some embodiments, the method includes translating, by the motion vector module, the motion vector defined in a first coordinate system of a remote controller into a second coordinate system of the motion vector module based on the control axis established by the motion vector module. In some embodiments, the method includes communicating, by the motion vector module, one or more commands to an engine controller of the self-propelled toy. In some embodiments, the method includes communicating, by the motion vector module, one or more executable commands to locomotion members of the self-propelled toy. In some embodiments, the method includes communicating, by the motion vector module, commands to the self-propelled toy to execute the motion in the same direction as the direction corresponding to displacement of at least a portion of the remote controller. In some embodiments, the method includes performing, by the motion vector module, auto-trimming of the self-propelled toy responsive to receiving a signal from the remote controller for at least a predetermined time period while the remote controller is maintained in a same position.

In some aspects, the present invention is directed to a system for receiving by a motion vector module of a self-propelled toy a motion vector transmitted remotely via a remote controller, the system comprises a self-propelled toy and a motion vector module of the self-propelled toy that establishes a control axis responsive to responsive to a direction of one or more signals from a remote controller. The motion vector module receives via the one or more signal a motion vector. the motion vector comprising a magnitude and a direction. The motion vector module translates the motion vector to a coordinate system of the motion vector module based on the control axis and communicates, based on an orientation of the self-propelled toy to the coordinate system, commands to the self-propelled toy to execute motion corresponding to the motion vector.

In some embodiments, the self-propelled toy comprises a visual indicator that the self-propelled toy has been selected for control by the remote controller. In some embodiments, the motion vector module establishes the control axis as one of parallel with or coinciding with a plane of projection of the one or more signals. In some embodiments, the motion vector module establishes the control axis within a predetermined angle from a plane of projection of the one or more signals. In some embodiments, the self-propelled toy comprises a visual indicator that the motion vector has been received. In some embodiments, the self-propelled toy comprises a visual indicator of a direction of the motion vector that has been received.

In some embodiments, the motion vector module receives the motion vector further comprising a duration for a motion specified by the motion vector. In some embodiments, the motion vector module receives a signal comprising a correction from a user to the motion vector.

In some embodiments, the motion vector module translates the motion vector defined in a first coordinate system of a remote controller into a second coordinate system of the motion vector module based on the control axis established by the motion vector module. In some embodiments, the motion vector module communicates one or more commands to an engine controller of the self-propelled toy. In some embodiments, the motion vector module communicates one or more executable commands to locomotion members of the self-propelled toy.

In some embodiments, the motion vector module comprises a multi-fold rotationally symmetrical optical sensor. In some embodiments, the motion vector module comprises a camera for receiving signals from the remote controller. In some embodiments, wherein the motion vector module comprises a set of photo detector sensors for receiving signals from the remote controller.

In some embodiments, the self-propelled toy comprises the motion vector module. In some embodiments, the motion vector module is separate from the self-propelled toy. In some embodiments, the motion vector module communicates commands to the self-propelled toy to execute the motion in the same direction as the direction corresponding to displacement of at least a portion of the remote controller. In some embodiments, the motion vector module performs auto-trimming of the self-propelled toy responsive to receiving a signal from the remote controller for at least a predetermined time period while the remote controller is maintained in a same position.

In yet some aspects, the present invention is directed to a method for controlling a group of self-propelled toys. The method may include selecting, by a remote controller, via transmission of one or more signals towards each of a plurality of self-propelled toys, a group of the self-propelled toys for which to send the same command for a motion to be performed. The method may also include detecting, by a sensor of the remote controller, a displacement of at least a portion of the remote controller and determining, by the remote controller responsive to the sensor, a motion vector corresponding to the displacement. The motion vector includes a direction and a magnitude of the displacement of the portion of the remote controller. The method may also include transmitting, by the remote controller, the same motion vector to each self-propelled toy of the selected group of self-propelled toys to request each self-propelled toy to perform the motion specified by the motion vector.

In some embodiments, the method includes receiving by each motion vector module of each self-propelled toy in the group of self-propelled toys, the motion vector and translating, by each motion vector module, the motion vector to a coordinate system of the motion vector module and a control axis established by the motion vector module. In some embodiments, the method communicating, by each motion vector module based on an orientation of the corresponding self-propelled toy to the coordinate system of the corresponding motion vector module, one or more commands to the corresponding self-propelled toy to execute motion corresponding to the motion vector. In some embodiments, the method includes determining by the sensor of the remote controller a duration of the displacement and transmitting the motion vector further comprising the duration. In some embodiments, the method includes each motion vector module directing the corresponding self-propelled toy in the group of self-propelled toys to perform the motion specified by the motion vector for the duration specified by the motion vector.

In some aspects, the present invention is directed to a method for remotely setting via an optical remote controller a motion vector on a self-propelled toy. The method may include receiving, by a motion vector module of a self-propelled toy, a beam of light from an optical remote controller pointed at the self-propelled toy and waiting, by the motion vector module responsive to receipt of the beam of light, for a predetermined time period for motion direction requests from the optical remote controller. The method may also include receiving, by the motion vector module during the predetermined time period, one or more commands from the optical remote controller to change a current motion vector. The method may include changing, by the motion vector module responsive to each of the one or more commands, the motion vector and providing, by the self-propelled toy responsive to each setting of the motion vector, one or more visual indicators of a current motion vector set on the self-propelled toy. The method may also include communicating, by the motion vector module responsive to not receiving commands from the optical remote controller for the predetermined time period, a command based on the current motion vector to the control engine of the self-propelled toy.

In some embodiments, the method includes transmitting, by the optical remote controller, the beam of light responsive to pressing a button on the optical remote controller. In some embodiments, the method includes providing, by the self-propelled toy responsive to a light sensor of a motion vector module, a first visual indicator that the self-propelled toy has been selected by the optical remote controller. In some embodiments, the method includes lighting, by the motion vector module, a light to indicate that that self-propelled toy is selected by the optical remote controller.

In some embodiments, the method includes switching, by the motion vector module, into a direction request mode responsive to a stop to transmission of the beam of light. In some embodiments, the method includes transmitting, by the optical remote controller, the one or more commands, such as via light pulses, responsive to clicking a button on the optical remote controller. In some embodiments, the method includes switching, by the motion vector module, to direction setting mode. In some embodiments, the method includes illuminating, by the motion vector module, a light of a plurality of lights of the self-propelled toy to indicate the setting of the current motion vector. In some embodiments, the method includes taking, by the motion vector module, the motion vector corresponding to the light currently illuminated upon expiration of the predetermined time period.

In some aspects, the present solution is directed to systems and methods of operating an RC and MV module using a predetermined signal width and sensitivity threshold. The RC may transmit a signal, such as a light beam, of a predetermined narrowness from a plurality of a possible width beams. A user of the RC may be able to select a first toy from a plurality toys within a predetermined proximity or closeness to each other by transmission of the signal/beam to the first toy. This may occur without any reflective signal or overlap of signal to any of the MV modules of the other toys. The MV module of the first toy may have a predetermined threshold sensitivity for detecting signals within a predetermined beam width from the RC. The MV module responsive to this predetermined threshold sensitivity detects and/or recognizes the signal from the RC falling within the threshold. The MV module may detect the direction and/or plane of the signal from the RC within a predetermined range of accuracy and/or preciseness. Accordingly, responsive to a measurement of direction and/or plane of the RC signal, the MV module may translate the orientation system of the RC to the orientation system of the MV module within a predetermined threshold of accuracy and/or preciseness. Likewise, the MV module responsive to the preciseness and/or accuracy of the detection of the direction and/or plane of the RC signal and the preciseness and/or accuracy of the translation of coordinate systems of the RC to the MV module the MV module may generate and communicate commands to effect motion in the toy in a direction, magnitude and duration within a predetermined threshold and/or accuracy corresponding to a displacement of at least a portion of the RC.

### BRIEF DESCRIPTION OF THE DRAWINGS

The present invention is more fully appreciated in connection with the following detailed description taken in conjunction with the accompanying drawings, in which:

FIG. 1 is a perspective view of an optical remote controller (RC) and a self-propelled toy containing motion vector (MV) module.

FIG. 2 is a superposed top view of the optical RC and the self-propelled toy bug.

FIG. 3 is a perspective view of a plurality of self-propelled toys controlled by different optical RCs.

FIG. 4 is a schematic of an embodiment of the optical sensor.

FIG. 5 is a block diagram of an embodiment of the optical sensor of FIG. 4.

FIG. 6 is a block diagram of an embodiment of the signal acquisition channel of the FIG. 5.

FIGS. 7A-7E show embodiments of steps for controlling a self-propelled toy with an embodiment of a simple optical RC.

FIG. 8 is a schematic top view of an embodiment of a control system comprising a simple camera at a toy.

### DETAILED DESCRIPTION

### Embodiments of Remote Controllers (RCs) and Toys

### Embodiments of a Joystick as an RC and an MV-Module at a Toy.

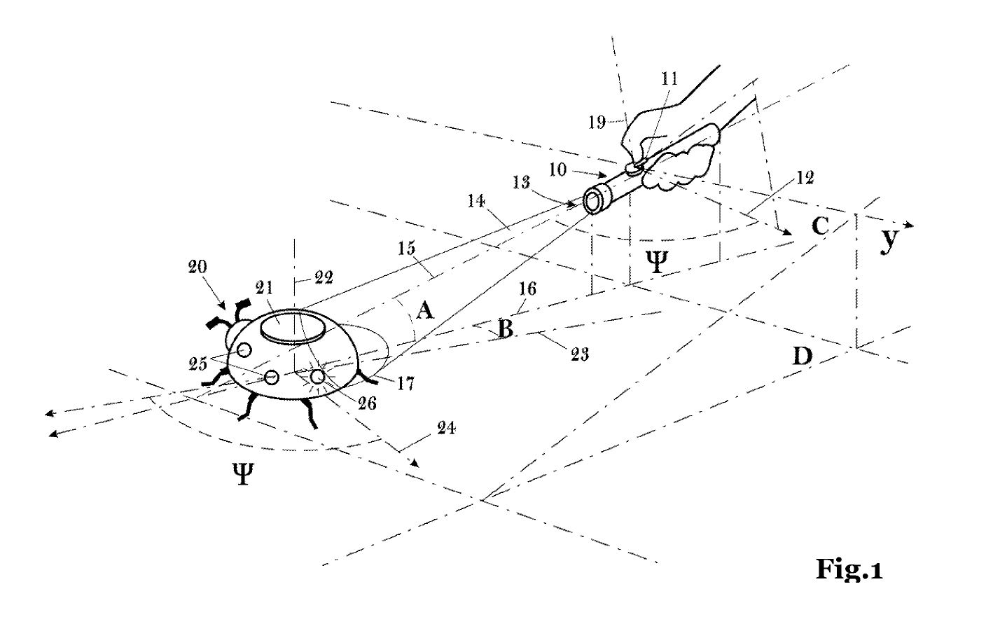

In FIG. 1 an exemplary embodiment of the present solution is schematically shown. Self-propelled toy bug 20 is remotely controlled by a user with remote controller (RC) 10. RC 10 emits a beam of light 14 which illuminates bug 20. The bug detects light from the RC light source 13. In response the bug can signal with its light indicators 25, 26 according to a preprogrammed algorithm. The user sees light spot 17 at bug 20 and/or its signaling indicators. Thus the user realizes the highlighted toy bug is selected. Once a self-propelled toy (toy robot) is selected it can be operated. In the embodiment shown in FIG. 1 this is being done by manipulating conventional joystick 11. Displacement of joystick 11 is detected, coded and transmitted by the means of RC 10 to a motion vector module (MV-module) attached to or built in a controlled toy. MV-module converts motion vector received in a coordinate system related to RC into a coordinate system related to MV-module (and toy). In the embodiment in FIG. 1 MV-module 21 is placed on the bug's back. In some embodiments, control stimuli are transmitted by modulation of light emitted by RC 10 although any known technology of data transmission by light can be used. TMV-module 21 receives information transmitted by the light beam 14 and either converts the information into executed commands or transmits the same to the toy's engine controller for further processing. TRC 10 may send commands periodically, such via a predetermined frequency, for example ten times per second. While the user keeps joystick 11 in the same slant position, the RC may continue sending the same command repeatedly.

### Embodiments of Setting a Desired Motion Parameters

A user intuitively may set a desired motion direction for the selected toy by shifting the joystick in the same direction. In FIG. 1 the controlled toy bug 20 is situated at surface D (floor, table, ground) that may be marked as plane D. Light beam axis 15 which is determined by a longitudinal axis of RC 10 held by user's hand lies in imaginary plane C which is perpendicular to the joystick neutral position axis 19. Light beam axis 15 may be taken as X-axis of plane C, and the orthogonal reference line passing trough the joystick's base may be taken as Y-axis. When the joystick is slanted its symbolic apex projection to the plane C gives two Cartesian coordinates of the terminal point of the bound vector. This vector may be a defining vector for the desired motion. The vector direction may define the desired motion direction while the vector magnitude may define the desired motion speed. In some embodiment, the third parameter of the desired motion—motion duration—may be set by time during which the joystick is kept displaced.

The obtained Cartesian coordinates are converted by the means of RC 10, such as via a microcontroller or processor of the RC into polar coordinates TΨ and r, where Ψ is the direction and r is the magnitude of defining motion vector 12. Ψ may be calculated relative to X-axis of the plane C. In FIG. 1 angle Ψ in plane C is shown as the angle between light beam axis 15 and defining motion vector 12. The two values Ψ and r may be transmitted by light modulation by a transmitter of the RC, Any toy robots captured by the light beam 14 may receive this information. Some additional information such as the mentioned above motion duration value or situational algorithmic code may be transmitted at the same time or in a separate transmission.

The RC may comprise a microcontroller, central processing unit or any other type and form of processor for executing executable instructions of any type and form, such as for obtaining and translating coordinates and creating/specifying a motion vector or otherwise performing any of the functionality and operation of the methods and techniques described herein. The processor maybe in communication with any type and form of sensor, such as an accelerometer, motion, photo sensor, camera or video camera, that detects displacement of or changes in displacement of a remote controller itself or any portion thereof, such as a stick of a joystick. The processor may be in communication with a transmitter for transmitting data to the MV module and/or toy. The processor may be in communication with a receiver for receiving data with the MV module and/or toy.

### Embodiments of Defining a Control Axis

MV-module 21 detects light emitted by RC 10 and defines direction to light source 13 as an axis lying in plane D (or a parallel plane). In some embodiments, this axis inverted by 180 P^{0P} is taken or established by the MV-module as control axis 23. In some cases, the defined control axis 23 is coinciding with (or parallel to) light beam axis projection 16 in plane D. This happens when light beam axis 15 passes through the center of MV-module 21, e.g., axis 15 intersects pivot axis 22 of the selected toy and direction to light source is detected accurately. As this position is not strictly required for selecting a controlled toy, so in a real game axis 15 usually more or less diverts from the toy's pivot 22 and some inaccuracy in direction measurement happens. Thus, in some cases, an angle appears between light beam projection axis 16 and the defined or MV established control axis 23. This angle is designated in FIG. 1 as angle B. In some embodiments, angle B may be practically 10 P^{0P} or less. In some embodiments, such degree of inaccuracy in defining or establishing a control axis is quite acceptable for toy robotics applications.

As soon as a control axis is defined and defining motion vector parameters are received by the MV-module it correlates these data with current toy's orientation and consequently sets task for toy's locomotion members for performing the desired motion. In FIG. 1 the defined or desired motion vector 24 lies aslant to the defined control axis 23 at angle Ψ which value is received from the RC. In some embodiments, the initial point of motion vector 24 is an intersection of control axis 23 and pivot axis 22.

The MV Module may comprise a microcontroller, central processing unit or any other type and form of processor for executing executable instructions of any type and form, such as for obtaining and translating coordinates and processing a motion vector or for performing any operations in accordance with the methods and techniques described herein. The MV processor may be in communication with any type and form of sensor such as, photo sensor, camera or video camera that detects signals from the RC. The processor may be in communication with a receiver for receiving data from the RC and/or toy.

### Embodiments of Toy's Intended Motion.

In some embodiments, a controllable toy has light indicators associated with its MV-module. These indicators may come in very different implementations, may be assembled in the same MV-module or may be not, may show one definite direction at a time or may have floating position etc. In any case light indication serves for evidently showing the selected toy and a defined motion vector to the user. In FIG. 1 light indicators 25, 26 are placed at the bug's side. Indicator 26 is active (for example, it is blinking), and thus the indicator shows the direction of the defined motion vector 24. Due to the light indication of the defined motion vector the user can correct the joystick displacement at once.

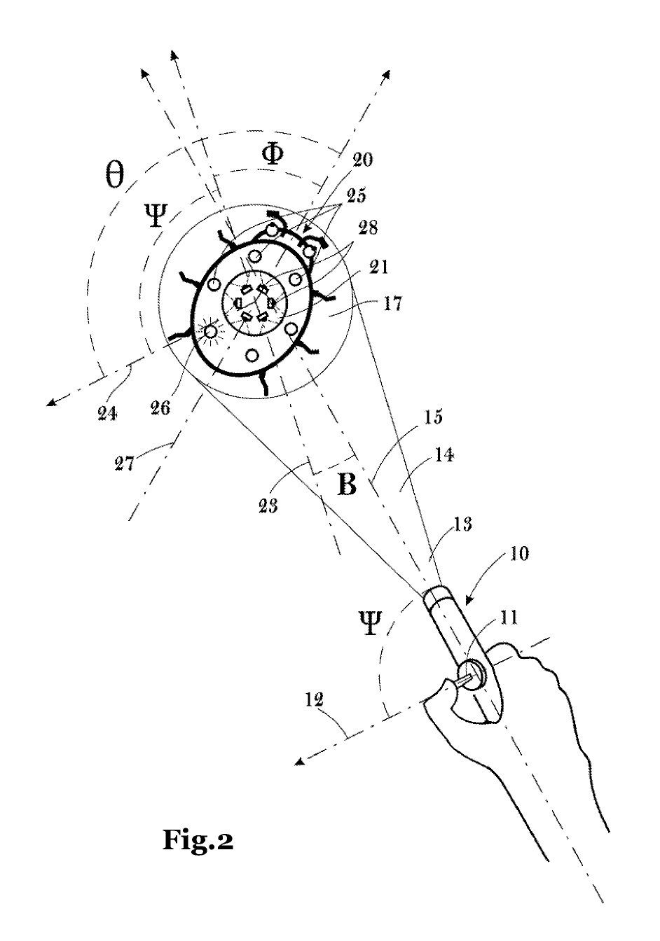

In FIG. 2 a top view at the handheld optical RC 10 and the self-propelled toy bug is shown so that planes C and D from FIG. 1 are superposed in the same projection. In FIG. 2 MV-module 21 is schematically shown with no cover on it, so that photo-sensors 28 arranged in a circle are seen. In FIG. 2 light beam axis 15 goes a little aside from the center of MV-module 21 but light beam 14 still affects photo-sensors 28, and thus the defining vector 12 parameters are received by the controlled bug 20. As photo-sensors 28 are actuated control axis 23 is defined which deflects from light beam axis 15 by angle B, that is considered in some embodiments an acceptable error in defining a control axis.

In FIG. 2 the desired motion vector 24 may be directed relative to control axis 23 by angle Ψ, while control axis 23 deflects from the bug's own longitudinal axis 27 by angle φ. And thus, in some embodiments, the desired motion direction relative to the bug's longitudinal axis 27 is defined as angle θ which is a sum of angles φ and Ψ. Indicator 26 closest to the defined motion direction is radiant while the other indicators 25 are inactive. Thus the user sees the intended direction which the 20 is going to go.

### Embodiments of Known Limitations, Permissible Inaccuracy.

Normally the user holds RC 10 in a position most convenient for remotely controlling the toy moving on surface D. In some embodiments, that position may have an (i) angle A between light beam 15 and its projection 16 in plane D is somewhat about 20 P^{0P}-60 P^{0P}, and (ii) Y-axis of the imaginary plane C is nearly parallel to plane D (FIG. 1).

In some embodiments, certain limitations of the method may be associated with abnormal positioning of RC 10 controlling toy 20. For example, if angle A is 90 P^{0P} then the proposed method does not work, because MV-module is unable to determine direction to the light source. For another example, if a user holds RC 10 in a position “joystick down” (instead of normal “joystick up”) then Y-axis of the imaginary plane C is inverted while position of light source 13 remains the same, and the defining motion vector 12 is inverted too while the defined control axis remains the same. As a result, the MV-module may define the wrong motion vector. However, the described abnormalities are very inconvenient in operation, very unlikely in practice and therefore may be neglected.

In some embodiments, inaccuracy may more likely in setting the defining motion vector when RC 10 is rotated around the RC's longitudinal axis by 45 P^{0P}-90 P^{0P} relative to the RC's normal position, and angle A is close to its upper threshold. The inaccuracy in these embodiments may happen because of the following perceptual phenomenon. What the user feels is a joystick position at plane C, what the user sees is the selected toy position at plane D, what the user wants is the toy's motion at plane D in a direction set in plane C. So the user unconsciously projects joystick displacement vector to plane D. Or it may be said the user mentally superposes plains C and D. (Such a superposed view is depicted in FIG. 2). When planes C and D are more or less close to mutually parallel positioning there is no any appreciable discrepancy between motion vector set at the RC and felt by sense of touch on one side and the mental projection of the desired motion vector at the plane D on the other side. But in a threshold position of the optical RC the said mental superposition may be erroneous. For example, if angle A is about 50 P^{0P}-60 P^{0P} and the RC is turned by about 60-70 P^{0P} relative to its normal position, then the joystick shifted to the left will actually show down-backwards, and it is perceived as directing backwards, not left. However, the described scenario is marginal. In a real game the perceptual discrepancy between the defining motion vector set at the RC on one side and the desired motion vector mentally projected or defined by the toy's MV-module will in many embodiments no exceed 10 P^{0P}-20 P^{0P}. And that degree of accuracy is more than acceptable for controlling self-propelled toy robots.

### Embodiments of a Multi-User Game.

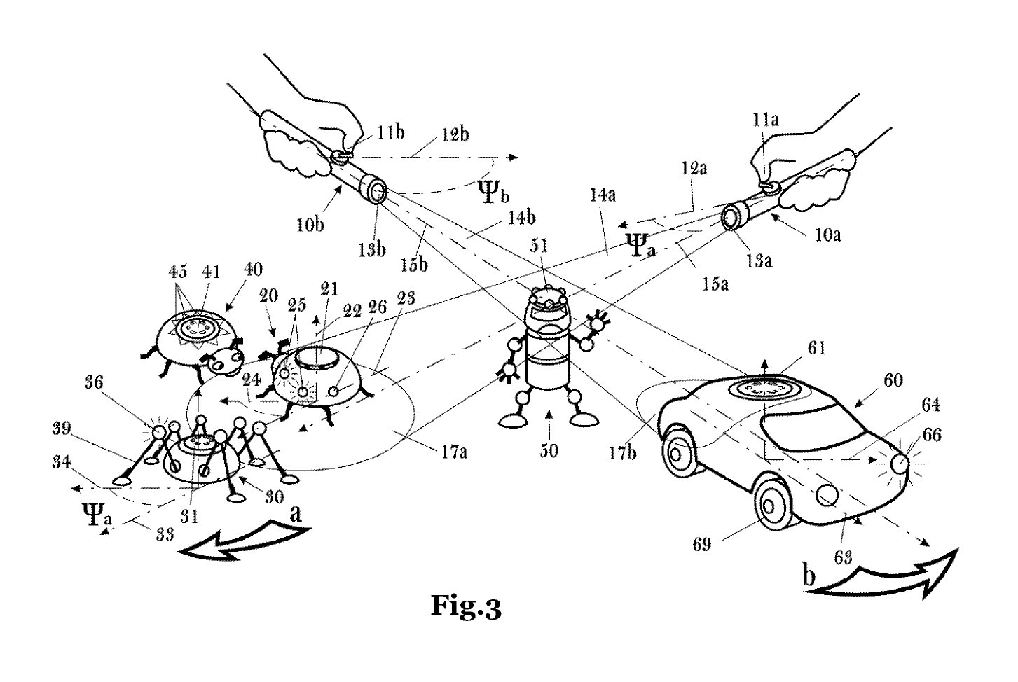

In FIG. 3 another aspect of the embodiments of the systems and methods of the present solution are shown. This is a game system comprised of a plurality of remotely controllable self-propelled toys and a plurality (at least two) of optical remote controllers (RCs). RC 10a radiates beam of light 14a towards a group of toys: bugs 20, 40 and robo-spider 30. RC 10b radiates beam of light 14 b towards toy car 60. Walking toy droid 50 occasionally is found on the way of light rays from the both light sources 13a and 13b. Joystick 11a of RC 10a is displaced, and thus it sets the defining motion vector 12a which goes aslant from light beam axis 15a at angle Ψa. Joystick 11b of RC 10b is displaced too, and thus it sets the defining motion vector 12b which deflects from light beam axis 15b by angle Ψb. The values of angles Ψa and Ψb along with the corresponding additional data are transmitted by the RCs 10a and 10b to the respectively selected toys.

In FIG. 3 bug 40 is situated out of light spot 17a which is depicted only for illustrative purposes. In fact, in some embodiments, the user may not see any light spot on the surface because of the ambient light influence. However, in some embodiments, a selected toy should be in some way highlighted. In FIG. 3 bug 40 may not be affected by light beam 14a, and the bug's MV-module 41 may not detect light source 13a, and therefore neither the bug's indicators 45 are blinking nor is the bug's reflective coating shining. Thus the user of RC 10a realizes bug 40 is not selected.

The bug 20 shown in FIG. 3 inside the illustrative light spot 17a may be selected by RC 10a. The bug 20 MV-module detects direction to light source 13a, defines control axis 23, receives the defining parameters for the desired motion and defines the desired motion vector 24 relative to control axis 23. The initial point for the defined motion vector 24 may be an intersection of pivot axis 22 and the floor's surface D. As the defined motion direction passes approximately between two light indicators 25, so both of them are shining while indicator 26 is not. The user of RC 10a sees what direction bug 20 is going to go.

Additional parameters of the desired motion (such as speed, duration, magnitude and others) defined by a selected toy may be indicated by lighting color, blinking frequency, floating of the indicated direction etc.

### Embodiments of Performing the Desired Motion May Depend on a Toy's Locomotion Design.

In the exemplary embodiment, bug 20 is able to turn around a pivot axis 22 by an arbitrary angle and then move straight ahead during one motion cycle. When motion vector for the first cycle is defined and indicated the bug turns to the desired direction and the indicators' lighting turns correspondingly. The bug may go ahead as far and as quickly as defined by the received desired motion parameters of the motion vector.

In FIG. 3, an embodiment of a robo-spider 30 is situated partly inside the illustrative light spot 17a. That means its MV-module 31 detects light source 13a, defines control axis 33 and receives information from RC 10a. In the exemplary embodiment of this invention spider 30 is a kind of toy able to move in one of pre-defined directions conditional on its locomotion design. In particular, spider 30 is able to move in one of six directions regarded to one of its six limbs. The direction of the defined motion vector 34 doesn't coincide with any of the six pre-defined directions though it is closer to the direction tied to limb 39. So the direction of limb 39 is taken for the desired motion. And light indicator 36 at limb 39 shows to the user the intended motion direction of spider 30.

In FIG. 3 MV-module 61 of toy car 60 is affected by the light from RC 10b that is illustratively shown by light spot 17b. The defined motion vector 64 relative to control axis 63 is corresponding to the defining vector 21b relative to light beam axis 15b. Vector 64 directs left-left-forward to the car. In the exemplary embodiment of the invention car 60 represents a class of self-propelled toys that cannot turn by an arbitrary angle around a vertical axis (like caterpillar tanks can do) but make their turns while advancing by arc (like most of cars). So car 60 indicates not the desired motion direction but the intended turn by switching on its left-forward winking light 66.

In the exemplary embodiment of the invention car 60 contains a sensor set connected to a controller (not shown in FIG. 3) for counting wheels rotation and measuring forward wheels' turn. The car's gearing is calibrated so that a definite number of the forward wheels revolutions in a definite steering gear position determines a turn of the car's longitudinal axis by a definite angle. And vice versa: the given turn angle Ψb determines a definite number of revolutions of the turned wheels 69. So while the car makes its arcuate turn the controller counts the number of the wheels' revolutions until it matches to the number determined by the given angle Ψb. At that moment the car aligns its forward wheels and continues its motion straight ahead at a speed and during time defined by joystick 11b displacement.

### Embodiments of Light Beams Intersection.

In FIG. 3 MV-module 51 of droid 50 is occasionally found in the rays of light emitted by both RC 10a and RC 10b. So the droid must decide which controller's commands it must perform. This depends on the preprogrammed algorithms of the droid and the RCs as well as on the settings made by the user prior to the game. For example, if the droid is preprogrammed to identify the first detected optical RC, then during the game the robot may perform only the commands received from the first RC and ignore commands sent to it by any other RC. After getting the first command the droid ignores all other RCs until it completes the received task. After finishing the task droid is “untied” and ready to accept a command from any RC. In order to give a command to the droid user should select it first, before any other users. This is an example of a “neutral” droid. As well it can be programmed to perform only the commands received from the first RC 11a and ignore commands sent to it by any other RC. That mean the droid belongs to RC 11a team.

Embodiments of More than One Motion Cycle May be Set at the RC and then Transmitted to a Selected Toy at Once.

In that case bug 20 at first performs a motion cycle defined by the first motion vector then changes direction and performs the next cycle.

### Embodiments of Grouping.

If some controllable toys are situated close to each other (comparing with the distance to an RC) so that direction to the light source from that RC for each toy differs insignificantly, then it is possible to control all the group at once. For performing a group control the user should
first, select all the toys (game units) to be included to the group; this may be done consequently by pointing the toys one by one, or it may be done at once by lighting all the group with a wide light beam;
second, give a command to be performed

For example, a user grouped several toys and send them a command “come to me!” by displacing the RC joystick straight backwards. In response to this command every toy in the group performs a turn by such an angle that its control axis directs to the RC and starts moving towards the RC (the user).

### Embodiments of MODULATION OF LIGHT

The remote controller may comprise any type and form of transmitter or transmission means to send data, data clocks, signals, packets, etc. to the MV module and/or toy. The remote controller may use the transmitter for communicating selection, control and commands to a self-propelled toy. The remote controller may use the transmitter for communicating motion vectors to a self-propelled toy. Any type and form of protocol may be used and data may be encoded using any type and form of encoding.

In some embodiments of a data block to be transmitted, the UART protocol is used for light modulation. Zero means “light ON”, one means “light OFF”. Such modulation can be implemented on a low cost micro controller containing built-in UART transmitter.

Handheld optical RC may transmit a data block containing several bytes. In the beginning of the block there may be a preamble—one or two bytes with equal number of ones and zeroes. In some embodiments, the main part of the block contains three payload bytes: one byte contains the remote controller's ID, second byte contains Ψ value, third byte contains r value. In the end of the block there may be CRC sum for data validation.

In expanded embodiments main part of data block may contain more information, i.e. more payload bytes. For example, T value (duration of the desired motion) may be transmitted. (T value may be determined by the duration of holding RC joystick in a definite position). As well a series of motion vectors may be transmitted at once, thus determining a desired motion trajectory.

Contrariwise, in some embodiments, a simplest packet may contain only one payload byte—an RC's ID. Such a packet may be sent periodically when user selects a toy to be operated but still do not make any command for a motion to be performed. When a toy receives such a packet it goes to “selected” mode and indicates this visually.

### Embodiments of Master RC Identification.

In multi-user games an RC identification may be required. This is done by transmitting the RC's ID within each data packet. In the beginning of the game (or prior to the game) every toy that a user wants to include to his/her team as a game unit is selected with the user's optical RC, and therefore such a selected toy is tied to its “Master RC”. During the game other RCs are being ignored or replied with a lower priority in compliance with a preprogrammed algorithm. Initial master RC identification may be made at once by grouping all the selected toys by the same optical RC, or it may be made sequentially by adding a newly selected toy from a no-man's reserve during the game.

Binding of a toy to its master RC may be made at a production line. Such pre-bound toys may be sold in sets along with their RCs. Otherwise a hidden button at a toy may be used for launching “programming master RC” mode. When such a toy is selected with an optical RC it gets the RCs ID with a transmission packet and stores it as “Master RC” ID. After master RC is defined a toy turns back to a normal mode and may be operated. The simplest binding can be made as follows: the first optical RC that selects a toy is taken by this toy as its master RC.

Binding of the selected toy to its master RC may be limited by time. On the expiration of the “lock time” a toy which was initially selected by a first user may be untied and change hands, i.e. it may be selected by a second user and temporarily tied to the second master RC. Depending on a preprogrammed algorithm some of the RCs (supervisor RC) may have higher priority concerning the others (ordinary RC). That means a supervisor RC may select and operate a toy tied to an ordinary RC, and the toy selected by the supervisor RC should follow its commands, not the command of its ordinary master RC. Such a priority may be hierarchically organized.

### Embodiments of Control Signal Overlapping.

An optical RC transmits data packets repeatedly at a random interval. The duration of an interval is several times greater than a packet transmission time. Data packets from different RCs may be sent to the same toy robot overlapped in time. That may happen, for example, when contesting toy robots operated by their respective users are disposed close to each other. Therefore at least one of them may be affected by light rays from at least two different RCs. That may lead to missing of at least one of the overlapped packets by the targeted toy. However, thanks to the said randomness, time of the next data packet transmission from one RC will not be overlapped by a transmission time from another RC.

In some embodiments, each transmitted packet contains complete information required for performing user's commands. It is enough for the operated toy to receive just one packet. Repeated transmission of identical data packets serves for advanced reliability: if one or two packets are lost a toy is still operatively controlled.

When two or more RCs are targeting the same untied toy, the toy should first, identify and second, indicate (show to the users) which one of the affecting RCs it takes as its master RC. For example, if two or more hierarchically equal RCs light at the same untied toy, the toy takes as its master the one, which data packet was successfully received first. As soon as master RC is identified the toy shows this with its indicator(s) directing to the master RC light source. After the master RC is identified and pointed, the toy shows the motion vector that was set at this RC.

### Embodiments of Combination of Visible and Invisible Light.

An invisible modulated light may be emitted together with a visible light beam. Invisible modulated light serves for transmitting control commands while visible light indicates selected toy or group of toys. For example, a toy train may by remotely controlled by an optical RC containing just two buttons—red and green. When red button is pressed visible red light is emitted, and invisible light transmits command “stop”. When green button is pressed visible green light is emitted, and invisible light transmits command “go”. When a user illuminates a toy train with green light the train goes. When a user illuminates moving train with red light the train stops. The same RC may be used for remotely controlling a toy railway semaphores. When a semaphore is illuminated with red light it switches on its own red light. Semaphore's red light is detected by an oncoming train, and the train stops. When a semaphore is illuminated with green light it switches on its own green light, that means the way is open. The same remote control method may be applied to a motorized toy railway stopper. When the stopper is illuminated with red light it switches “on” and a train cannot pass it through. When the stopper is illuminated with green light it switches “off”, and the way is open.

### Embodiments of MOTION VECTOR MODULE (MV-Module).

### Embodiments of MV-Module Functions

According to embodiments of the present solution motion vector module (MV-module) is a microelectronic device built in or attachable to a self-propelled toy (robot) operated by an optical remote controller (optical RC). MV-module itself or in coupling with other members of a self-propelled toy (robot) provides any one or more of the following functions:
(i) detects light emitted by an optical RC pointed at it or otherwise detects a remote controller directed at it (oriented towards it)
(ii) determines its master RC and hereupon follows its master RC commands at higher priority relative to other detected RCs; the priority order defined by a preprogrammed algorithm
(iii) detects direction to the effecting light source based on its optical sensor measures or otherwise detects mutual spatial positioning of the selected toy and the selecting RC
(iv) receives commands from the effected RC containing the RC's ID, desired motion vector parameters (the defining motion vector) relative to the RC's directing axis and additional information depending on the preprogrammed algorithm
(v) converts the received data into the desired motion vector (the defined motion vector) relative to the toy's saggital axis
(vi) indicates visually status of the selected toy, its defined control axis and the defined motion vector
(vii) get a correction for the desired motion from the user
(viii) either transmits the desired motion vector parameters to the toy's engine controller for further processing or converts the defined motion vector into executed commands in accordance with the toy's locomotion engine
(ix) transmits executed commands to the toy's locomotion members

If a desired motion cannot be exactly performed because of the engine's limitations, then motion vector values are reduced to the closest possible values convertible to executed commands. In some embodiments, the desired is translated to a closes motion that may be performed by the self-propelled toy.

Other embodiments are possible for providing the same or similar functions of an MV-module, based on any one or more of the following:
measuring direction to a controlling RC
data transmission from an RC to a selected toy
master RC identification

### Embodiments of Rotationally Symmetric Optical Sensor.

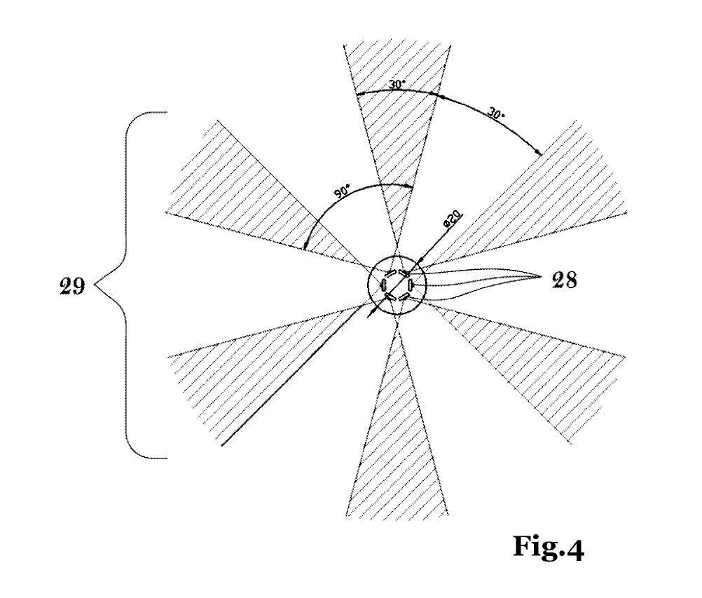

In FIG. 4, an embodiment of the optical sensor of the MV-module is schematically shown. In the depicted embodiment, six sensing blocks 28 are arranged in a circle for all-round detection of the effecting light sources. Although the optical sensor may be generally described herein as being a six-fold symmetrical optical sensor, the sensor may any multiple-fold sensor and may be symmetrical or not symmetrical. In some embodiments, the optical sensor may be a two-fold rotational sensor. In some embodiments, the optical sensor may be a three-fold rotational sensor. In some embodiments, the optical sensor may be a four-fold rotational sensor. In some embodiments, the optical sensor may be a five-fold rotational sensor. In some embodiments, the optical sensor may be a seven or more fold rotational sensor. In some embodiments, may be any N fold rotational sensor, where N is any desired or suitable number.

Spherical coordinate system relative to a self-propelled toy is adopted where zenith is vertical direction and zero azimuth angle is forward direction of the toy. Optical sensing block 28 receives data transmission from an RC and measures azimuth angle of the RC in this coordinate system. Measurement of zenith angle and radial coordinate is not required. Yet sensing block 28 may not work correctly if zenith angle is too small (45 P^{0P} or less). In such a case MV-module still can detect it is selected but cannot determine direction to the light source. However, normally a user is distanced from a controlled toy by 1 m or more that means zenith angle is 45 P^{0P} or more.

In some embodiments, the optical sensor depicted in FIG. 4 is six-fold rotationally symmetrical. The sensor may consists of six sensing blocks each detecting RC transmission in 90 P^{0P} sector (azimuth angle, viewing area). Viewing area of each photo-sensor 28 intersects with viewing areas of two neighboring photo-sensors. All the six photo-sensors disposed along a circumference are equally interspaced between each other. In TABLE 1 below azimuth “borders” for viewing areas are noted.

TABLE 1

| Sensing block number | Viewing sector start | Viewing sector end |
|---|---|---|
| 1 | 0 | 90 |
| 2 | 60 | 150 |
| 3 | 120 | 210 |
| 4 | 180 | 270 |
| 5 | 240 | 330 |
| 6 | 300 | 30 |

In FIG. 4, embodiments of 12 equal recognizable sectors are determined, each limited by 30 P^{0P} angle. In FIG. 4 six recognizable sectors are shown hatched while six others are clear. If an incoming light comes through a clear area it is sensed by one related sensing block. If an incoming light comes through a hatched area it is sensed by the two related neighboring sensing blocks. If the sensing blocks (one or two) which detect RC transmission are known, then it can be determined which recognizable sector for the detected light source and estimate azimuth angle of the light source position. That's shown in TABLE 2 below.

TABLE 2

| Which sensing block | Recognizable | Recognizable | Estimated |
|---|---|---|---|
| detects transmission | sector start | sector end | azimuth angle |
| 1 | 30 | 60 | 45 |
| 1 and 2 | 60 | 90 | 75 |
| 2 | 90 | 120 | 105 |
| 2 and 3 | 120 | 150 | 135 |
| 3 | 150 | 180 | 165 |
| 3 and 4 | 180 | 210 | 195 |
| 4 | 210 | 240 | 225 |
| 4 and 5 | 240 | 270 | 255 |
| 5 | 270 | 300 | 285 |
| 5 and 6 | 300 | 330 | 315 |
| 6 | 330 | 360 | 345 |
| 6 and 1 | 0 | 30 | 15 |

In some embodiments, the RC is assumed to be in the middle of a sector, so average azimuth angle between sector start and sector end is reported as result of RC azimuth angle measurement. Certainly true azimuth angle can differ on up to 15 P^{0P}, but this inaccuracy is acceptable in embodiments of this system.

In some embodiments, the optical sensor receives only direct transmission from an RC. But it may receive reflected light as well. The same transmission may be received by three or even more sensing blocks. That causes a mistake in azimuth angle estimation. For avoiding such a mistake each sensing block measures power of the received signal. The measured values are being sent to a decision unit. When some sensing blocks (at least one) have received a transmission the decision unit finds out which block has received a signal of maximal power. In some embodiments, this maximal power is power of direct light from an RC. Reflected light power is several times lower. A threshold power level is set by the decision unit relative to maximal transmission power level (several times lower). Reflected light signals and/or other parasite signals that do not override the threshold level are thrown out. Direct light signals are evaluated and azimuth angle is estimated according to TABLE 2.

Any of the information in Tables 1 and 2 may be designed and constructed for the number of folds and/or symmetry of the optical sensor. Any of the data or information of these tables may be stored in any type and form of memory and/or storage element of the MV modules, RC and/or toy.

### Embodiments of Optical Sensing Block

In some embodiments, any type and form of sensing block or sensor may used to receive transmission from an RC, such as optical RC. The Sensing block may comprise any of the following:
Photo-sensor (for example photo-transistor)
Electronic circuit
Case

In some embodiments, the photo-sensor converts light signal into an electrical signal.

In some embodiments, the case restricts viewing angle of photo-sensor. For example it should provide receiving signal in azimuth angle sector 90 P^{0P} and in zenith angle from 40 P^{0P} to 90 P^{0P}. In some embodiments, the borders of azimuth angle should not be dependent on zenith angle (angle between vertical axis and direction to optical RC). However, in practice such dependence does exist in some embodiments, and may cause adjustment in direction by 10 P^{0P} or a little more, which may be acceptable.

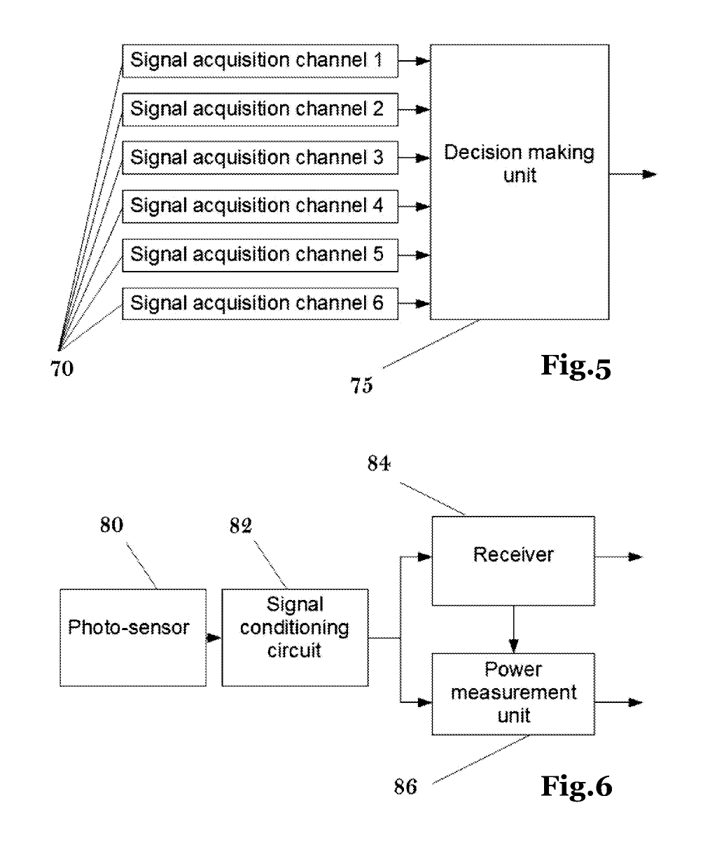

In FIG. 5 an embodiment of an optical sensor consisting of decision making unit 75 and six signal acquisition channels 70 is shown.

FIG. 6 is a block diagram of an embodiment of an electronic circuit of signal acquisition channel 70. The electronic circuit contains photo-sensor 80 (a photo-transistor may be used in some embodiments), signal conditioning circuit 82, receiver 84, power measurement unit 86. In some embodiments, the Signal conditioning circuit 82 performs any one or more of the following:
gets signal from photo sensor
suppresses low frequency (below 1 kHz) components in the signal
amplifies usable frequency components (usually in 1 kHz-100 kHz range)
provides an output in voltage with a reasonable amplitude (for example, 0±1V).

Receiver 84 gets a signal from signal conditioning unit 82 and decodes the transmission (if any). The receiver discards any data packet which is not destined to it (i.e. a packet which has come from other than the current master RC source). The accepted data is being supplied by the receiver to decision making unit 75.

When the receiver accepts data, the receiver may send a relevant signal to power measurement unit 86. In response the power measurement unit measures power of the signal accepted by the receiver. If no relevant signal from the receiver comes to the power measurement unit it doesn't measure power of a signal coming from the signal conditioning unit.

### Embodiments of Auto-Trim.

In some embodiments, the remotely controlled toy vehicles have what is called a “trim” option. This option is used for adjusting straightforward motion of a vehicle. Otherwise it will significantly deviate to the right or to the left. That happens because of imperfection of mechanics used in cheap toys. Cheap vehicle cannot precisely adjust their wheels' position according to RC commands. Usually “trim” option is performed by pressing right/left trim-buttons at an RC: when in response to “forward” command a vehicle deviates too much to the left a user adjusts vehicle's wheels position by pressing right trim-button and vice versa. Once a vehicle is adjusted like this (trimmed) it is able to keep going more or less straight.

In some embodiments, the MV-module may be used for performing “trim” option automatically. This may be done by continuous holding light-emitting RC pointed at the moving toy during several seconds. The joystick should be kept in the same position until auto-trim is completed. In this case the controlled toy tends to keep rectilinear motion by keeping constant an angle between its control axis (or direction to the RC light source) and its motion direction. However, in some embodiments, a toy controlled in this way circumscribes a circle, a spiral or a straight line depending on an angle of the RC joystick displacement (angle Ψ). For performing auto-trim a controlled toy should go rectilinearly. That means angle Ψ at the RC should be equal 0 P^{0P} or 180 P^{0P}. In other words, in some embodiments, a controlled toy should go straight away or straight towards the emitting RC light source pointed at the toy.

For example, the controlled toy goes straight away from the RC. Joystick at the RC directs straight forward (Ψ=0). The defined motion vector coincides with the toy's sagittal axis and its control axis. The MV-module aims to keep the control axis coincided with the toy's sagittal axis (φ=0). When the toy starts deviating from its straight way its control axis deviates as well. The MV-module sends a relevant signal to the toy's locomotion members. And the toy returns to its straight way.

In some embodiments, for a better performing auto-trim option, the MV-module may be designed so that a deviating angle of a toy's control axis (angle φ) might be registered as early and precisely as possible. MV-module having auto-trim option should be designed by a skilled in the art designer properly. In the described above six-fold rotationally symmetric optical sensor (section 5.3.2) vision field bounds of an appropriate photo-sensor(s) are set so that low deviations from controlling light beam lead to significant change of signal power. That might be used for measuring minor deviations.

### Embodiments of Continuous Control

In some embodiments, after getting motion vector and starting movement the selected toy continues receiving signals from the RC. In this case latest command replaces previous one. User can use this feature for continuous control of a toy. In this mode user keeps light spot on a toy, and the toy immediately reacts on joystick displacement.

Continuous control can be very useful if toy is unable to execute command “turn on given angle” with required precision. That's is typical for cheap toys which have no odometeric or navigation sensors. In this case user should keep light spot on motion module until the toy turns on required direction and starts going straightforward. In simplest case toys controller after receiving signal from RC needs to choose only from three options: “turn left”, “go straightforward”, “turn right”. By using the disclosed method it can choose appropriate turn direction until toy's forward direction became coincided with required motion vector, and then it starts moving straightforward. Toy uses RC as “navigation beacon” to control it own turning.

### Embodiments of Built-in Vs Attachable.

The MV-module may be designed and constructed to be a separate item attachable to a toy or may be designed and constructed to be included in or built as part of the toy. The MV-module may be made as a separate item attachable to different toys. The MV-module may be designed and constructed to be compatible with, interface to with the data communication, electrical and/or mechanical construction of the toy. The attachable MV-module may be made compatible with the toy, e.g. contain means for data communication with the toy. In some embodiments, means for data communication may not require any sockets or ports. In some embodiments, data exchange should be made through intact housing walls of both a toy and a MV-module. This may be done with the following communication means:
IR
magnetic coupling
UWB

Plastic conventionally used in toys may be transparent for the said means. Attachable MV-modules compatible with different kinds of self-propelled toys may be sold to end users as separate items.

### Embodiments of MOTION VECTOR INDICATION.

### Embodiments of a Degenerated Case.

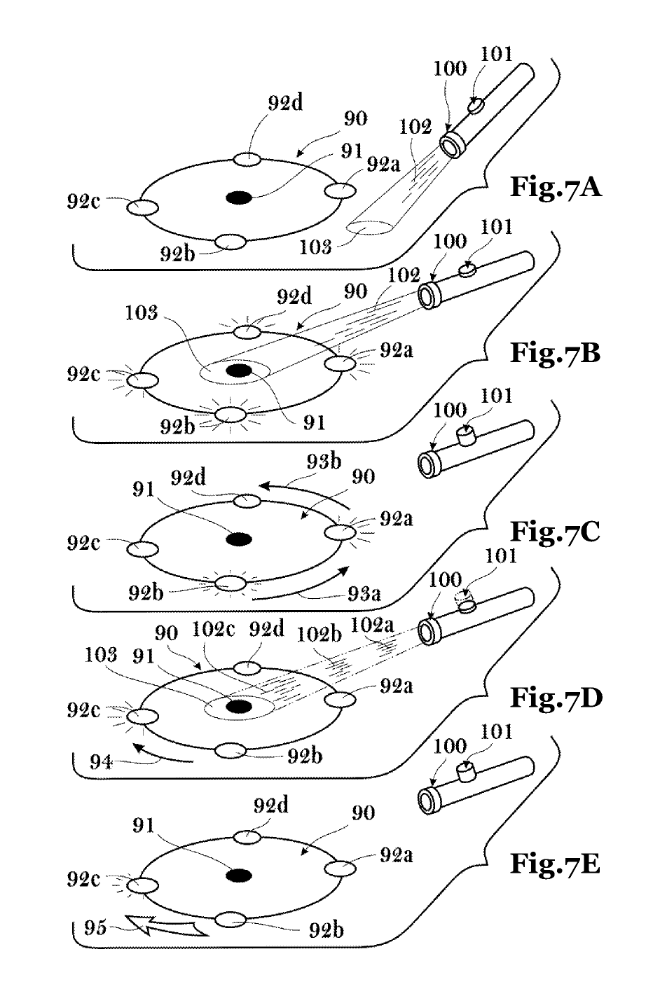

For better understanding of embodiments of the purpose of the motion vector indication, a degenerated case is described herein. In this embodiment, a primitive optical RC may be used. The RC may be as simple as an ordinary pocket flashlight with the only button which is ON when pressed and OFF when released. No encoding is made on the RC—the RC can just light or not light. The rest is made at an MV-module attached to a self-propelled toy. This system is quite suitable for setting a motion vector and remotely driving a robotic toy. Embodiments of this degenerated case is schematically depicted in FIGS. 7A to 7E which show some successive steps for setting motion direction for a selected toy.

In FIG. 7A a simple MV-module is schematically shown. MV-module 90 is comprised of a light sensor 91 which may be, for example, a cheap photodiode, four indicating lights 92a, 92b, 92c and 92d which may be, for example, cheap Leeds and a controller (not shown in FIG.) which controls work of the said sensor and lights. The MV-controller may be a simple mediator between the toy's controller and the MV-module members or it can produce commands and send them directly to the toy's locomotion members. This is not essential for the case.

In FIG. 7A a simplest pocket torch 100 is schematically shown as well. Its button 101 is pressed, so the torch is ON. Its beam of light 102 projects light spot 103 at the same surface on which a toy carrying MV-module 90 is situated. In FIG. light sensor 91 is not affected by light emitted by RC torch 100 (light spot 103—which is depicted only for illustrativeness—is projected aside the MV-module 90). No RC signal is detected by MV-module 90, so its light indicators 92a, 92b, 92c, 92d are OFF.

In FIG. 7B RC torch 100 is directed at a controlled toy (not shown in the schematic pictures 7A-7E). Button 101 is continuously pressed. Beam of light 102 emitted by the RC torch is pointed at the toy's MV-module 90. Therefore light sensor 91 is actuated (it is schematically shown by light spot 103 which covers light sensor 91). Hereupon an appropriate signal is sent to the controller, and the MV-module turns to “selected” mode which is displayed to the user by switching ON its light indicators. In the exemplary embodiment depicted in FIG. 7B light indicators 92a, 92b, 92c, 92d are simultaneously brightly shining. That means the toy (not shown in the schematic picture) is in “selected” mode, the user sees the toy is selected and can set a motion vector for it.

Motion vector is set by clicking (shortly pressing) the same button 101 which is used for selecting a toy while being continuously pressed.

In FIG. 7C button 101 is released and light sensor 91 is no more illuminated by light emitted by torch 100. Therefore MV-module 90 turns to “direction request” mode in which it stays for some short time interval (several seconds). The same happens is the user simply moves the switched on torch out of the selected toy so that its light sensor 91 is no more affected by the torch light. “Direction request” mode is displayed by a flashing carousel of the indicators 91a, 91b, 91c, 91d which are lighting up one by one in short intervals (say, 0.5 sec. or less). In FIG. 7C light 92a is brightly flashing while light 92b has just a residual glow and light indicators 92c and 92d are completely faded out. Arrows 93a, 93b show light carousel spin.

If nothing happens during “direction request” mode, then in some short time the light carousel stops, all the lights fade out, and the toy goes to “unselected” mode (initial or default state). If the “direction requesting” MV-module is continuously illuminated again it switches all the lights ON, comes back to “selected” mode in which it stays until the continuous illumination interrupts. On the contrary, if during the “direction request” mode MV-module detects short light impulses it sets motion direction for the selected toy.

In FIG. 7D light emitted by RC torch 100 is pointing on MV-module 90. This is shown as light spot 103 covering light sensor 91. Button 101 is shown pressed (solid line) and released (dotted line) at the same time. That means button 101 is not continuously pressed but clicked in the same manner as a button of a computer mouse. Therefore emitted light is symbolically shown as a series of successive light “impulses” 102a, 102b, 102c.

As soon as “direction requesting” MV-module 90 detects a short light signal (“impulse”) it stops light carousel at its current point. Last light indicator remains flashing while the others stay faded out. The MV-module turns to “direction set-up” mode. The active indicator indicates the desired motion direction. When the next click of button 101 is detected the next light indicator starts flashing instead of the previous one. In FIG. 7D arrow 94 shows motion direction shift in response to each click at the RC torch 100. Each time a light impulse is detected by sensor 91a signal is sent to the controller, it changes the desired motion direction by one step that is displayed by flashing of the next light indicator. In FIG. 7D the desired motion direction is indicated by the shining light 92c. If no more clicks are detected in some short time (2-3 sec.) during “direction set-up”, then the last position of an active light indicator is taken as the desired motion direction and sent to the controller as a command to be performed.

In FIG. 7E flashing light 92c indicates the defined motion vector direction which is also shown by arrow 95. Button 101 at the RC torch is released. No additional light signals are sent to MV-module 90. Therefore it turns to “motion execution” mode. The controller converts the defined motion vector into an executed command which is sent to the toy's locomotion module. The toy starts going.

In the described above exemplary embodiment motion vector may be defined only by its direction. In some embodiments, the vector magnitude may be as well be set by the same means. In other embodiments, different ways may be used. For example motion vector magnitude may be determined by duration of continuous illumination of the MV-module in “selected” mode. Or it may be determined by number of clicks made in “direction set-up” mode. Or by another ergonomically reasonable way.

### Embodiments of a Torch Plus Rotary Encoder.

In some embodiments, the described above simplest pocket torch used as a remote controller may be completed with some additional means for more usability. For example, a rotary encoder (instead of the simple button) at an RC may be used for adjusting the indicated motion direction. A user turns the adjustment knob at the RC and indicating light at the selected toy runs along the indicator circumference accordingly.

### Embodiments of Roughly Defined Control Axis, Precisely Set Motion Vector.

In some embodiments, the MV-module comprising tree optical sensing blocks is used. Sensing blocks may be arranged in a circle so that each block is able to detect light in a sector of approximately 120 P^{0P} or a little less. In some embodiments, there are no intersections between the three sectors. In other embodiments, there may be intersections between the three sectors. When one of the blocks is actuated that means a light source is emitting somewhere inside the sector of 120 P^{0P}. Thus, in some embodiments, just a very rough determination of the direction to the light source (emitting RC) is provided. Accordingly light indication of the MV-module is presented by tree sectors of 120 P^{0P}. However, in some embodiments, inside of each sector there might be placed several dot light indicators. Therefore, in some embodiments a user may in first step roughly determine a direction as a lighting sector and in a second step adjust the determined direction as a lighting dot indicator.

### Embodiments of Narrow Beam Communications Between RC and MV Module

In some embodiments, the RC is designed and constructed to transmit or emit a beam within a predetermined range of narrowness. In some embodiments, the RC is designed and constructed to transmit or emit a narrow beam of visible/invisible light. This is contrary to typical RC construction of other solutions which make the beam as wide as possible to increase the opportunity of reception by a receiver and to allow the RC to be oriented in wide range of orientation and still transmit a signal that can be received by the receiver. With a narrow beam design of some embodiments of the RC of the present solution, a user can more easily select one toy from a plurality of toys that are near each other. The signal transmission of the RC may be designed and constructed with a predetermined width to allow a predetermined preciseness and/or accuracy in the selection and control of a toy either in certain noisy signal environments or among a plurality of toys that are within a certain proximity of each other. For example, the RC signal may be designed and constructed to prevent another toy within a predetermined proximity of a toy to be selected from being selected and/or operated by the signal of the RC such as due to reflection of the signal off the surface of the toy intended for selection.

Furthermore, by transmitting a beam within a predetermined range of narrowness, the accuracy of coordinate translation may be improved between the RC and MV module. The MV module is able to translate from the coordinate system of the RC to the coordinate system of the MV module based on the detection of the direction and/or plane of the signal(s) from the RC. In some embodiments, the accuracy and/or preciseness of the detection by the MV module of the direction and/or plane of the signal from the RC may be based on the width of the signal from the RC. In some embodiments, with the width of the signal within a predetermined range of narrowness, the MV module may be able to detect the direction and/or plane of the signal within a predetermined range of accuracy and/or preciseness.

Accordingly, in some embodiments, the MV module may be designed and constructed to detect signals from the RC within a predetermined threshold of sensitivity. This threshold may be set or established to provide a predetermined level of accuracy and/or preciseness with the translation of coordinate systems between the RC and the MV module and/or to the effect of motion of the toy based on the translation. In some embodiments, the RC and MV module may establish or coordinate a selection of a predetermined beam width/narrowness and/or sensitivity threshold for the current environment, such as via an initialization or synchronization procedure. In the example embodiments of the multi-fold optical sensor of the MV module described above, the information and data described in Tables 1 and 2 as well as the sensor may be designed and constructed to support the desired beam width and threshold sensitivity.

### Embodiments Using TOUCH-SCREEN INPUT.

As described herein, a desired motion parameters can be set by a simple button, by a rotary encoder or another input device instead of joystick. The sensor of the remote controller may detect any type and form of displacement of any portion of the RC, include a simple button, a rotary encodes or movement of a member such as a handle of a joystick.

Desired motion vector can be set at an RC with any type and form of touch-screen as well, such that the detection of the displacement of a portion of the remote controller includes detecting movement via a touch screen. For example, initial and final points of the user's finger move at the touch screen may set motion vector direction and magnitude. Speed and duration of the desired motion may be set as well by user's finger move characteristics. Besides touch-screen input at an RC provides expanded abilities for quick and simple setting a desired motion curvilinear path. User finger's path at the touch-screen can be converted by the RC controller into a sequence of motion vectors and transmitted to a controlled toy. In some embodiments, the toy performs the sequence of motion vectors and therefore reproduced the desired path at a surface supporting the toy (floor).

### Embodiments of DIFFERENT COMMUNICATION MEANS

In some embodiments, the present solution uses modulated light for data transmission. However, any type and form of communication means may be used in, such as in order to increase transmission reliability and/or operability of remote controllers. These means include without any limitation any of the following:
radio frequency (RF)
infra-red (IR)
ultrasonic
ultra wideband (UWB)
   and any other appropriate, suitable or desired communication means.

### Embodiments of SETTING MOTION VECTOR WITH AN ACCELEROMETER

In this embodiment user selects a controlled toy by light emitted by a hand-held remote controller as described. In some embodiments, the desired motion vector is set at the RC with an accelerometer attached to the distant end of the RC. User sets direction and other parameter of the desired motion by a gesture of the hand in which the RC is held.

T Accelerometer measures acceleration in two directions: vertical and horizontal. Vertical acceleration directed upwards means a command to the controlled toy to move straight away from the user, e.g., in a direction of the toy's control axis as defined herein. Vertical acceleration directed downwards means a command to the controlled toy to move straight towards the user, e.g., in a direction of the inversed control axis, in other word directly towards the detected light source. Horizontal acceleration sets motion direction orthogonal to the control axis.

The RC, such as via any type of micro-controller or processor, converts acceleration measured in Cartesian coordinates into polar coordinates Ψ and r, where Ψ is direction and r is amplitude of the said gesture displacing distant end of the RC.

In the end of user's controlling gesture the controlled toy may be found out of light emitted by the RC, and in some cases, data transmission may be interrupted. This embodiment may detect not motion but acceleration. In some embodiments, acceleration may be measured and sent to the controlled toy before the toy appears out of the RC-emitted light beam. In some embodiments, acceleration is maximal in the first moment of movement and acceleration may be determined and Ψ and r values transmitted before transmission is interrupted because the controlled gesture has moved the light beam away from the controlled toy.

In some embodiments, horizontal and vertical acceleration are measured. The accelerometer measures acceleration along a given axis related to its case. In some embodiments, a device may be designed so that acceleration measurement axis is vertical when a user holds a device in a typical manner. However a user can rotate an RC (at least by 30-50 degrees) and decline the accelerometer. Gravitation direction can be used for avoiding this inaccuracy. In some embodiments, the acceleration sensor is sensible to constant acceleration (like popular MEMS sensors of Analog Devices company). In some embodiments, the sensor may be used to determine vertical direction related to accelerometer case and so calculate vertical and horizontal acceleration. In some embodiments, a signal from the accelerometer feeds two filters: lowpass (below fl Hz) and highpass (above fh Hz). If input is x signal then output of lowpass filter is designated as xs (x slow). and output of highpass filter as xf (y fast). If input is y signal then output of lowpass filter is designated as ys (y slow) and output of highpass filter as yf (y fast).

In some embodiments, high pass filter passes through acceleration of sharp RC motion (a controlling gesture when user issues a command), but this filter rejects gravity and slow motion. Low pass filter rejects acceleration of sharp RC motion (a controlling gesture when user issues a command), but this filter passes through gravity and slow motion. In some embodiments, output of a Low pass filter is used to obtain direction of gravitation and therefore obtain rotation angle of RC case related to vertical axis. High pass filter provides direction of gesture acceleration related to RC case. Together these values provide direction of gesture acceleration related to true vertical and horizontal.

### Embodiments Using BUILT-IN VIDEO-CAMERA.

### Embodiments of a Video-Camera at a Remote Controller.

In some embodiments, a video-camera may be mounted at the distant end of an optical remote controller and may (i) register spot of light emitted by its RC at a surface (playing field), (ii) recognize a toy to be operated and (iii) distinguish toy's “non-selected” or “selected” status due to reflected light and/or light indication at the toy. Besides, in wide-angle regime RC-camera may record and recognize path patterns or signs “written” by the light spot. For example, when a user sees an obstacle on the way of the controlled toy machine that should be passed round (enemy robot etc.), the user may point light at the machine and then draw a by-pass with light spot starting at the controlled toy machine and ending at a destination point. In some embodiments, the camera records the by-pass route which is then converted to a sequence of motion vectors and/or other motion parameters which are further transmitted to the controlled machine.

### Embodiments of a Video-Camera at a Controlled Toy.

In some embodiments, a video-camera may be mounted at a self-propelled toy and play a role of MV-module, e.g., detect light emitted by an RC and determine direction to the light source. In that case, light modulation frequency should be much lower (1-100 Hz) than the same used for detecting by photo-sensors. As an image of the RC light source is distinguished from the background due to light modulation then in some embodiments the requirements to camera focusing and resolution are significantly decreased. For example, if light source image (spot) occupies even up to quarter of the camera light-sensitive surface it is still possible to define zenith and azimuth angle by determining the light spot position. As small as tens of pixels photosensitive matrix is quite acceptable for this kind of camera. This gives a possibility to use very simple and cheap camera implementations. In some embodiments, the video camera may be built into the MV module. In some embodiments, the video camera may be attachable or connectable to the MV module.

If data from an RC is transmitted by modulated light, the MV may receive signals from several RCs simultaneously. In particular, an MV may to receive data from master RC even while the device is illuminated by other RCs; and in some embodiments, this is a notable advantage. However, in some embodiments, in order to increase data transmission rate and simplification of MV-module camera it may be reasonable to use another, more fast channel for data transmission.

In some embodiments, the MV-module optics is designed and constructed to meet any or more of the following requirements or otherwise having the following functionality:
optics is radial-symmetrical
photosensitive surface is perpendicular to radial symmetry axis
optics is able to receive and project to the photosensitive surface light beams diverging from the axis of radial symmetry by an angle of 0 P^{0P}-90 P^{0P} (90 P^{0P} divergence occurs when an effecting RC is positioned very close to a toy motion surface (floor, table etc.), that is very unlikely, and so this third requirement may be tempered in consideration of minimal altitude and maximal remoteness of an RC position).

Besides, as opposed to the majority of cameras and optical systems, in some embodiments, ray focusing is not required (that means it is not required to focus rays from a point in a real space into an image point in a photosensitive area). Provided that noted above requirements in some embodiments are met the optics maps a dot light source (that's what RC is taken as) into a bilateral symmetrical image which symmetry axis is a projection of any line passing trough a dot light source and intersecting the radial symmetry axis.

This way fixing of bilateral symmetry axis of the mapped image enables the definition of the azimuth angle. And in some embodiments by fixing displacement of the image center on the photosensitive surface from the area center (point in which the radial symmetry axis intersects the photosensitive surface) one can define the zenith angle. As the optics is radiosymmetrical so azimuth angle value has no effect on the zenith angle dependence of the image displacement, the said dependence therefore may be calibrated. As a result such a sensor is able to define both: zenith angle and azimuth angle. Center of the image (spot) may be defined by any one of the algorithms known in the art of image processing. In some embodiments, this may be required though the center of this bilateral symmetrical image is located in the symmetry axis.

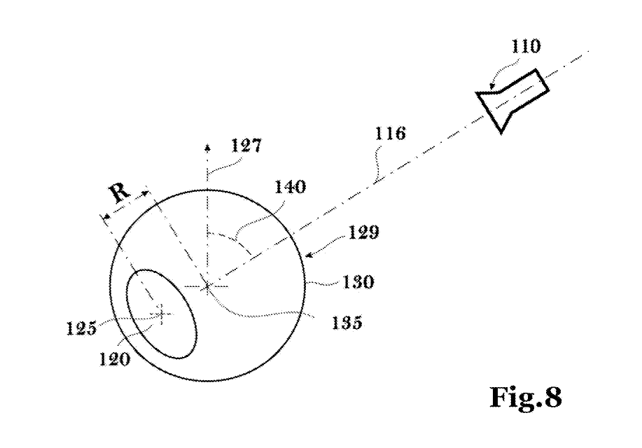

In FIG. 8, an embodiment of a schematic top view of the described above control system is shown. Optical remote controller (RC) 110 emits light towards a toy (not show in FIG. 8) carrying a camera which photosensitive surface 129 is limited by circle 130. Radial symmetry axis for surface 129 is a vertical seen in the top view as point 135 which is the center of circle 130. Light from RC 110 is mapped on photosensitive surface 129 as spot 120. In FIG. 8 the bilateral symmetry axis for spot 120 coincides with control axis 116 (direction to light source). Azimuth may be defined as angle 140 between control axis 116 and the toy's sagittal axis (forward direction) 127. Zenith may be calculated out of distance R between the photosensitive surface center 135 and the spot center 125. In some embodiments, a camera of sufficient quality or design may be used at or as part of a toy for recognizing gesture signs “drawn” with the RC light by user's hand.

In some embodiments, the camera may be built into the MV module. In some embodiments, the camera may be attachable or connectable to the MV module.

Although the systems, methods and techniques described herein are generally described in connection with a self-propelled toy, these systems, methods and techniques are not limited to toys. These systems, methods and techniques described herein may be applied to any type and form of controller to control any type and form of self-propelled device.

1-6. (canceled)

7. A method for remotely setting a motion vector for a self-propelled toy, the method comprising:
(a) selecting, by a remote controller via transmission of a signal towards a self-propelled toy, the self-propelled toy to which to send a command for a motion to be performed;
(b) detecting, by a sensor of the remote controller, a displacement of at least a portion of the remote controller;
(c) determining, by the remote controller responsive to the sensor, a motion vector corresponding to the displacement, the motion vector comprising a direction and a magnitude of the displacement of the remote controller; and
(d) transmitting, by the remote controller, the motion vector to the selected self-propelled toy to request the self-propelled toy to perform the motion specified by the motion vector.

8. (canceled)

9. The method of claim 7, wherein step (a) further comprises providing a visual indicator of selection based on a light spot on the self-propelled toy and a surface supporting the self-propelled toy.

10. The method of claim 7, wherein step (a) further comprises providing a visual indicator of selection based on light from the remote controller reflecting off a reflective portion of the self-propelled toy.

11. The method of claim 7, wherein step (a) further comprises providing a visual indicator of selection based on the self-propelled toy switching on a light source of the self-propelled toy.

12-16. (canceled)

17. The method of claim 7, wherein step (c) further comprises specifying a duration of the motion vector based on a time for which at least the portion of the displacement of the remote controller is kept.

18. The method of claim 7, wherein step (d) further comprises transmitting, by the remote controller, the motion vector to the self-propelled toy via one of the following transmission mediums: light, radio frequency (RF) infra-red (IR), ultrasonic and ultra wideband (UWB).

19. The method of claim 7, wherein the sensor comprises one of the following: an accelerometer, a joystick or a camera and a touch screen interface.

20. The method of claim 7, wherein step (d) further comprise transmitting, by the remote controller, the motion vector to the self-propelled toy to request the self-propelled toy to perform the motion in the same direction as the displacement of at least the portion of the remote controller.

21-34. (canceled)

35. A method for receiving by a motion vector module of a self-propelled toy a motion vector transmitted remotely via a remote controller, the method comprising:
(a) establishing, by a motion vector module of a self-propelled toy responsive to a direction of one or more signals from a remote controller, a control axis;
(b) receiving, by the motion vector module, a motion vector via the one or more signals, a motion vector comprising a magnitude and a direction;
(c) translating, by the motion vector module, the motion vector to a coordinate system of the motion vector module based on the control axis; and
(d) communicating, by the motion vector module based on an orientation of the self-propelled toy to the coordinate system, commands to the self-propelled toy to execute motion corresponding to the motion vector.

36. (canceled)

37. The method of claim 35, wherein step (a) further comprises establishing, by the motion vector module, the control axis as one of parallel with or coinciding with a plane of projection of the one or more signals from the remote controller.

38-39. (canceled)

40. The method of claim 35, wherein step (b) further comprises communicating, by the self-propelled toy responsive to the motion vector module, a visual indicator that of a direction of a motion vector received by the motion vector module.

41. The method of claim 35, wherein step (b) further comprises receiving, by the motion vector module, the motion vector further comprising a duration for a motion specified by the motion vector.

42. The method of claim 35, wherein step (b) further comprises receiving, by a multifold rotationally symmetrical optical sensor of the motion vector module, signals from the remote controller.

43. The method of claim 35, wherein step (b) further comprises receiving, by a camera of the motion vector module, signals from the remote controller.

44. (canceled)

45. The method of claim 35, further comprising receiving, by the motion vector module, a signal comprising a correction from a user to the motion vector.

46. The method of claim 35, wherein step (c) further comprises translating, by the motion vector module, the motion vector defined in a first coordinate system of a remote controller into a second coordinate system of the motion vector module based on the control axis established by the motion vector module.

47-48. (canceled)

49. The method of claim 35, wherein step (d) further comprises communicating, by the motion vector module, commands to the self-propelled toy to execute the motion in the same direction as the direction corresponding to displacement of at least a portion of the remote controller.

50. The method of claim 35, further comprising performing, by the motion vector module, auto-trimming of the self-propelled toy responsive to receiving a signal from the remote controller for at least a predetermined time period while the remote controller is maintained in a same position.

51-68. (canceled)

69. A method for controlling a group of self-propelled toys, the method comprising:
(a) selecting, by a remote controller, via transmission of one or more signals towards each of a plurality of self-propelled toys, a group of the self-propelled toys for which to send the same command for a motion to be performed;
(b) detecting, by a sensor of the remote controller, a displacement of at least a portion of the remote controller;
(c) determining, by the remote controller responsive to the sensor, a motion vector corresponding to the displacement, the motion vector comprising a direction and a magnitude of the displacement of the portion of the remote controller; and
(d) transmitting, by the remote controller, the same motion vector to each self-propelled toy of the selected group of self-propelled toys to request each self-propelled toy to perform the motion specified by the motion vector.

70-82. (canceled)

83. The method of claim 35, further comprises detecting, by a camera of the motion vector modules, a dot light source provided by the remote controller and translating into a bilateral symmetrical image which symmetry axis is a projection of a line passing through the dot light source and intersecting the radial symmetry axis.

84. (canceled)
